(19) United States
(12) Patent Application Publication
(10) Pub. No.: US 2006/0090321 A1
(43) Pub. Date: May 4, 2006

(54) Apparatus for removing fasteners and method regarding same

(75) Inventor: Donald W. Haines JR., Waco, TX (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(73) Assignee: Huck International, Inc.

(21) Appl. No.: 10/981,344

(22) Filed: Nov. 3, 2004

(51) Int. Cl. B23P 19/02; B23P 21/00

(52) U.S. Cl. 29/426.4; 29/715

(57) ABSTRACT

A nose assembly structured to be mounted to an actuator of the type having a base and a translatable piston. The nose assembly being structured to be cooperable with a swaged fastener by grippingly engaging a collar swaged to a pin. The nose assembly being structured to cut the collar to facilitate its removal from the pin. The nose assembly has a sleeve with a distal end and a proximal end, one or more chuck jaws located in the interior of the sleeve; and one or more cutting blades. When the collar of the fastener is received into the sleeve, the chuck jaws may engage the collar and hold the collar in place when the collar is received into the sleeve and the cutting blades may cuttingly engage the collar along a cutting direction generally parallel with an axis of the fastener.

### FIELD OF THE INVENTION

The invention relates generally to fasteners and, more particularly, an apparatus for removing a fastener from another structure and a method regarding same.

### BACKGROUND OF THE INVENTION

Swaged fasteners and associated tooling disclosed in U.S. Pat. No. 5,315,755 to Fulbright et al. are known for use in numerous applications. An exemplary fastener of this type includes a pin and a collar, with the collar being swageable onto the pin. Specifically, the pin might include an enlarged head and a shank, with a shank having locking grooves or threading on an exterior surface thereof. The collar can be swaged into engagement with the shank, i.e., swaged into the locking grooves or the threading, which causes the fastener to become fastened. While such fasteners have been generally effective for their intended purposes, such fasteners have not, however, been without limitation.

Such swageable fasteners have been employed widely in a variety of applications in which componentry is expensive and the fasteners often must be installed in cramped confines. A swaged fastener must be removed from the structures to which it is mounted if the fastener has been swaged improperly or if the apparatus otherwise must be disassembled. Some previously known methodologies for removing swaged fasteners have employed chisel-type devices and hammers, or alternatively have employed cutting torches, with such methodologies often resulting in breakage of the componentry to which the fastener is mounted and/or raising safety concerns and/or being relatively slow.

As is understood in the relevant art, the pin of such a fastener is significantly harder than the collar and tooling that cuts into the pin while removing the collar therefrom will necessarily have a very short lifespan. Also, numerous known machines for removing the collars from swaged fasteners are relatively large and thus are difficult to employ within the cramped confines of a variety of applications.

It thus is desired to provide an improved apparatus for cutting a collar of a swaged fastener to facilitate removal of the swaged fastener from componentry to which it is mounted. Such an apparatus preferably would function without shock loading of the swaged fastener or the components on which the fastener is mounted, would not raise safety concerns of the type raised in conjunction with the use of cutting torches, and would operate relatively quickly. Such an apparatus preferably also would be easily used within the cramped confines in which the swaged fastener is mounted. Moreover, such an apparatus preferably would be relatively inexpensive to manufacture and employ and also would have a relatively long lifespan.

### SUMMARY OF THE INVENTION

An improved fastener removal apparatus in accordance with the present invention meets these and other needs. An improved fastener removal apparatus is configured to remove a swaged fastener by grippingly engaging a collar swaged to the pin. The fastener removal apparatus includes a nose assembly that can be mounted to an actuator of the type having a base and a translatable piston. The nose assembly includes a sleeve with one or more chuck jaws, and one or more translatable cutting blades. When the collar of the fastener is received into the sleeve, the chuck jaws may engage the collar and hold the collar in place. While the collar is engaged within the chuck jaws, the cutting blades cuttingly engage the swaged collar in a direction generally parallel with an axis of the collar thereby facilitating the removal of the collar from the pin of the fastener.

An aspect of the present invention is to provide an improved fastener removal apparatus that can remove a swaged fastener from a component without damaging the component.

Another aspect of the present invention is to provide an improved fastener removal apparatus that can be operated in cramped confines in which a swaged fastener has been mounted.

Another aspect of the present invention is to provide an improved fastener removal apparatus that does not raise safety concerns of the type raised in conjunction with the use of cutting torches.

Another aspect of the present invention is to provide an improved fastener removal apparatus having a nose assembly that is mountable to an actuator of the same type as is employed in performing a swaging operation on a fastener.

Another aspect of the present invention is to provide an improved fastener removal apparatus for use with a swaged fastener of the type not having a threaded pin to which the fastener removal apparatus could threadably be cooperated with.

Another aspect of the present invention is to provide an improved fastener removal apparatus that can be used to remove conventional threaded fasteners, such as conventional nuts and bolts.

Another aspect of the present invention is to provide an improved fastener removal apparatus that is relatively inexpensive to manufacture and operate.

Another aspect of the present invention is to provide an improved fastener removal apparatus having a relatively long life span.

Another aspect of the present invention is to provide an improved fastener removal apparatus that operates relatively quickly.

Another aspect of the present invention is to provide an improved fastener removal apparatus for removing a swaged fastener of the type having a swaged collar by grippingly engaging the collar swaged to the pin, wherein the fastener removal apparatus includes a blade that cuttingly engages the collar along a cutting direction generally parallel with an axis of the pin when relative translation occurs between the blade and the collar along the cutting direction.

Accordingly, an aspect of the present invention is to provide an improved nose assembly structured to be mounted to an actuator of the type having a base and a translatable piston, in which the nose assembly is structured to be cooperable with a fastener of the type having a collar, with the collar being affixed to the pin, and with the nose assembly being structured to cut the collar to facilitate its removal from the pin. The general nature of the nose assembly can be stated as including a sleeve that is structured to be mounted to one of the base and the piston, one or more chuck jaws that may engage the collar when the collar is received into the sleeve, and one or more cutting blades. The cutting blades are structured to be mounted to the other of the base and the piston and translateably cut the collar in a direction generally parallel with an axis of the collar to cutting engage the cutting blades with the collar.

Another aspect of the present invention is to provide an improved method of removing a collar from a pin, in which the general nature of the method can be stated as including providing a fastener release tool including an actuator, one or more chuck jaws, and one or more cutting blades. The method comprises gripping the collar with the chuck jaws and translating the cutting blades with the actuator along a cutting direction generally parallel with an axis of the pin, and cuttably engaging the blades with the collar along the cutting direction to form one or more cuts in the collar.

### BRIEF DESCRIPTION OF THE DRAWINGS

A further understanding of the invention can be gained from the following Description of the Preferred Embodiments when read in conjunction with the accompanying drawings in which:

FIG. 1 is a cross sectional side elevational view of an improved fastener removal apparatus in accordance with a first embodiment of the present invention;

FIG. 2 is a cross sectional side exploded view of FIG. 1;

FIG. 3 is a cross sectional side view of the first embodiment during a cutting operation preformed on a collar of a swaged fastener;

FIG. 4 is an exploded isometric view of a portion of a nose assembly of the first embodiment; and

FIG. 5 is an isometric view of a portion of a nose assembly of the first embodiment.

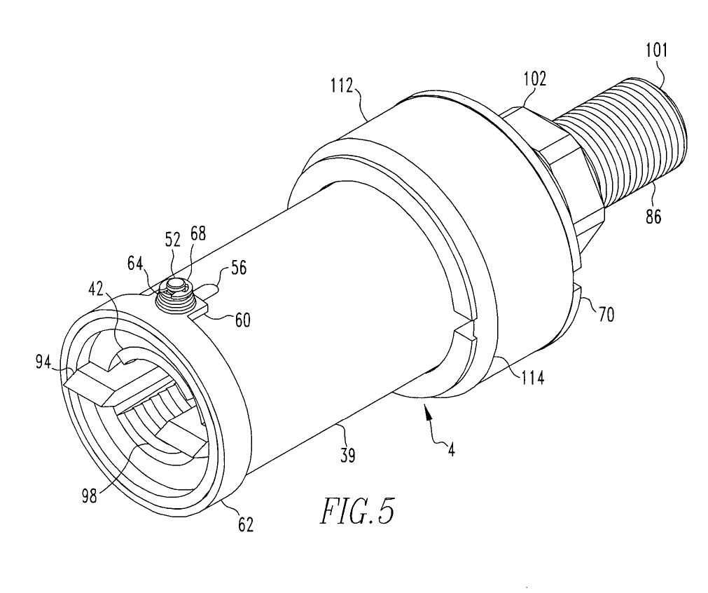

### DETAILED DESCRIPTION OF PREFERRED EMBODIMENTS

The expression “thread” and variations thereof, as well as depictions, shall refer broadly to helical or annular threading, single or multiple pitch, and shall additionally refer to other attachment formations that could include concentric grooving, knurling, and other roughening methodologies.

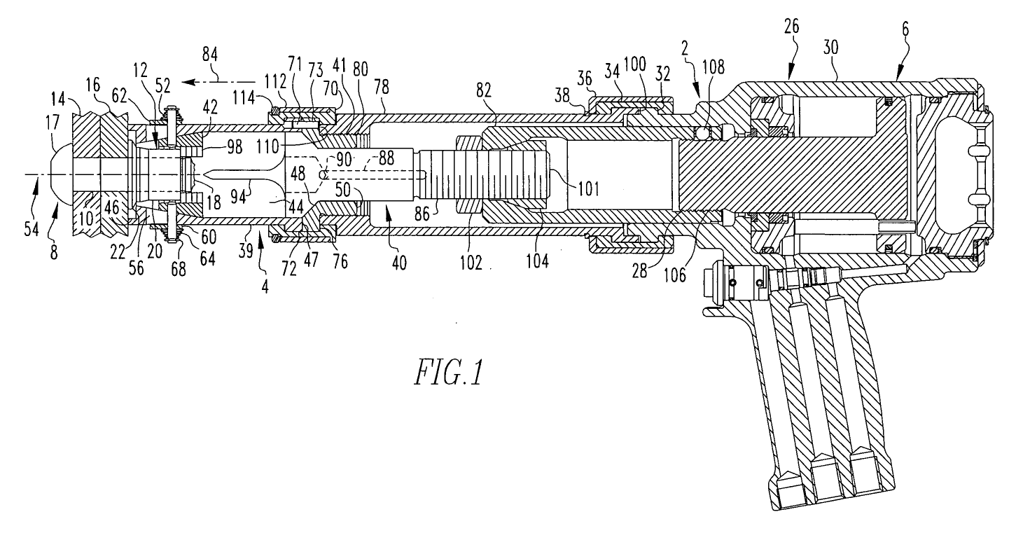

An improved fastener removal apparatus 2 in accordance with a first embodiment of the present invention is indicated generally in FIGS. 1, 2 and 3. The fastener removal apparatus 2 includes an improved nose assembly 4 and a known actuator 6. The apparatus 2 is cooperable with a swaged fastener 8 to permit removal of the fastener 8 from structures upon which it is mounted.

As can be understood from FIG. 1, the fastener 8 is any of a wide variety of swaged fasteners of the type having a pin 10 and a collar 12, with the collar 12 being swaged to the pin 10. It is particularly noted that the fastener 8 could be of other configurations, such as non-swaged configurations, which for example would include the circumstance of conventional threaded fasteners that have a nut secured to the pin and fasteners that employ an interference fit.

The fastener 8 can be employed to fasten together structures such as, for instance, an exemplary first plate 14 and an exemplary second plate 16. The pin 10 includes an enlarged head 17. The collar 12 is swaged onto the shank 18 and includes a swaged region 20 and a flared region 22. While the collar 12 is shown as having a flared region 22, a generally tubular collar 12 that does not have a flared region 22 may be used as well. The swaged region 20 is swaged into engagement with the shank 18, which affixes the collar 12 to the pin 10. The flared region 22 is engaged with the second plate 16, and the head 17 is disposed against the first plate 14, whereby the first plate 14 and second plate 16 are fastened together between the head 17 and the flared region 22 of the collar 12. The fastener 8 is depicted herein as being properly swaged, although it is noted that the fastener removal apparatus 2 likewise cooperates with a fastener 8 that has not been properly installed onto the first and second plates 14 and 16.

The actuator 6 can be generally described as including a base 26 and piston 28, with the piston 28 being translatable with respect to the base 26 upon operation of the actuator 6 in a known fashion. The exemplary actuator 6 is hydraulically operated, but can be of other configurations (e.g., pneumatic, electric, etc.) without departing from concept of the present invention.

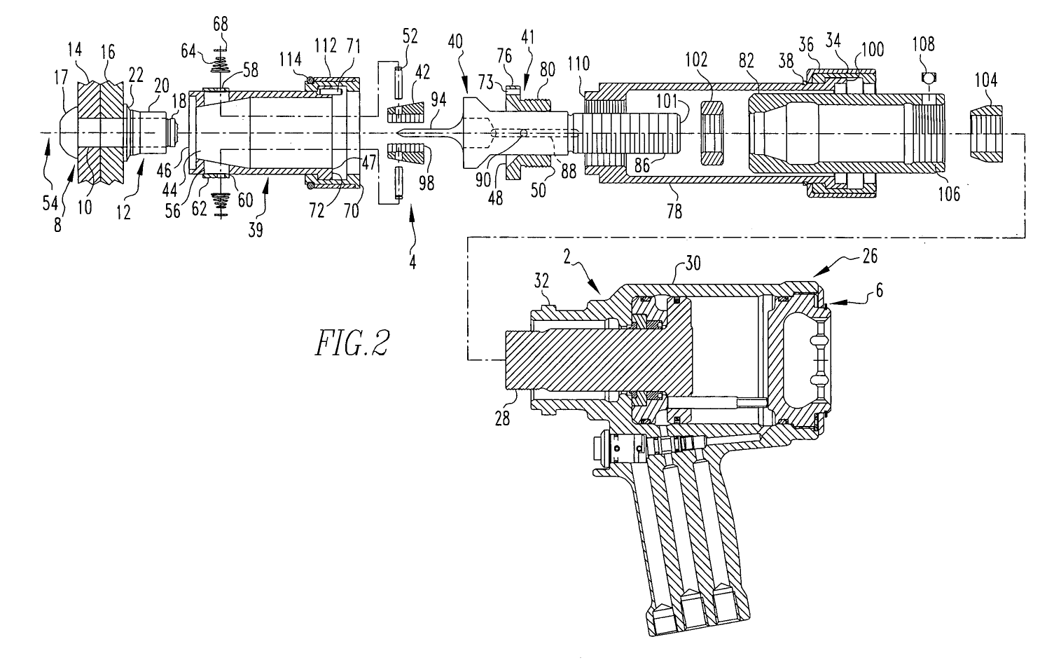

As shown in FIG. 2, the base 26 includes a housing 30 having a ridge 32 formed thereon, a plurality of rear half-rings 34, a rear clamp ring 36, and a rear snap ring 38. As can be understood from FIG. 1, and as will be described in greater detail below, a portion of the procedure in attaching the nose assembly 4 to the actuator 6 includes receiving the nose assembly 4 against the ridge 32, attaching the rear half-rings 34 about the region of engagement between the ridge 32 and the nose assembly 4, receiving the rear clamp ring 36 about the installed rear half-rings 34, and mounting the rear snap ring 38 to retain the rear clamp ring 36 in an attached condition. As can be appreciated, other attachment devices with different configurations could be devised for securing the nose assembly 4 to the actuator 6 or other tools.

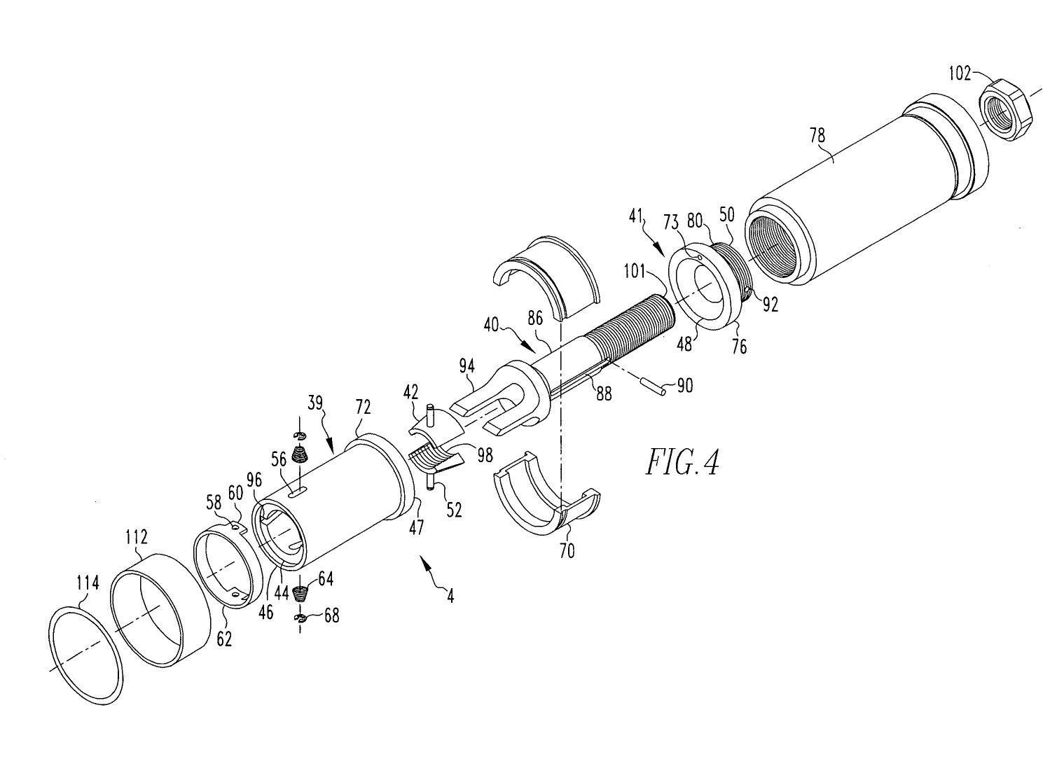

FIGS. 2 and 4 show that the nose assembly 4 can be generally described as including a first sleeve 39, a second sleeve 41, cutting blades 40, and chuck jaws 42. The first sleeve 39 has an interior surface 44 that tapers toward a distal end 46, a proximal end 47, a generally tubular body with a through bore that passes through the interior surface 44 and a preselected length. The second sleeve 41 also has a distal end 48 and a proximal end 50. The chuck jaws 42 are held within the interior surface 44 of the first sleeve 39 by pins 52 that extend from apertures disposed in an exterior surface of the chuck jaws generally perpendicular to an axis 54 of the fastener 8 from the chuck jaws 42 through slots 56 disposed within an exterior surface of the first sleeve 39 into the interior surface 44 and through apertures 58 disposed on laterally extending tabs 60 of a clip or retaining ring 62 into an interior of biasing members 64. The biasing members 64 are secured to the pins 52 by stop clips 68. The first and second sleeves 39 and 41 are connected by a plurality of front half-rings 70 that are installed about a flange 72 located on the first sleeve 39 at the proximal end 47 and a flange 76 located on the second sleeve 41 at the distal end 48. The first sleeve 39 has a pin 71 (see FIGS. 1-3) that is attached to the first sleeve 39 and extends from the proximal end 47 and is slideably received within an aperture 73 that is located on the distal end 48 of the second sleeve 41. The pin 71 prevents the first and second sleeves 39 and 41 from rotating in different directions once the front half-rings are installed about the flanges 72 and 76. As can be appreciated, other attachment devices with different configurations could be devised for securing the first sleeve 39 to the second sleeve 41 or directly securing the first sleeve 39 to the second sleeve 41 without using the front half-rings 76, front clamp ring 112 and front snap ring 114 or other attachment devices. For example, it is possible for the first sleeve 39 and the second sleeve 41 to be manufactured as an integral or unitary component. The second sleeve 41 is threadably connected to a second sleeve holder 78 by a threaded portion 80 of the second sleeve 41 located about an exterior surface of the second sleeve 41. As seen in FIG. 1, the second sleeve holder 78 may connect the second sleeve 41 to the base 26 with a pair of rear half-rings 34, a rear clamp ring 36 and a rear snap ring 38. As can be appreciated, one of ordinary skill in the art could conceive of alternative attachment devices for securing the second sleeve 41 to the base 26 or directly securing the second sleeve 41 onto the base 26 without using the second sleeve holder 78 or other attachment devices. The cutting blades 40 and a cutting blade holder 82 are connected together and operatively connected to the piston 28. It will also be appreciated by one of ordinary skill in the art that the cutting blades 40 could also be attached to the piston 28 by alternative attachment devices for securing the cutting blades 40 to the piston 28 or directly securing the cutting blades 40 to the piston 28 without using the cutting blade holder 82 or other attachment devices. As will be described in greater detail below, operation of the actuator 6 translates the piston 28, and the cutting blades 40 along a cutting direction represented by an arrow 84 to cut the collar 12 away from the pin 10.

As can be best understood from FIG. 1, the cutting blades 40 include a cylindrical structural member 86 with a first end and a second end that engages the cutting blade holder 82 and a slot 88 that extends along a preselected length of the cylindrical structural member 86. The cutting blades 40 are disposed on the first end of the cylindrical structural member 86 and threads are disposed on the second end of the cylindrical structural member 86. The cutting blades 40 may be provided with an elongated cutting edge. FIG. 4 shows that the slot 88 receives a pin 90 that extends through an aperture 92 disposed through an exterior surface of the second sleeve 41 into an interior surface of the second sleeve 41 thereby preventing the cutting blades 40 from rotating during the cutting operation. The cutting blades 40 depicted in FIG. 4 have a pair of blades 94. However, one of ordinary skill in the art would recognize that other embodiments may include one or more blades 94 and the depiction of a pair of blades 94 in FIG. 4 should not be considered a limitation of the present invention. The blades 94 are slidingly disposed within grooves 96 that are formed in the interior surface 44 of the first sleeve 39. In an alternative embodiment, one could use a single blade slidingly disposed within a single groove in the first sleeve 39 that could be employed by performing two or more separate cutting operations on the fastener 8, with the fastener removal tool 2 being rotated a partial turn between each cutting operation. The blades 94 are depicted in the exemplary embodiment as being equally circumferentially spaced from one another, but the blades could be spaced in a non-equal fashion depending upon the particular needs of the specific application. In the exemplary embodiment of the cutting blades 40 depicted herein, the cutting blades 40 include a pair of the blades 94 disposed in a substantially collinear fashion. Other numbers of blades 94 may be employed without departing from the scope of the present invention, it being understood that such a collinear relationship may or may not exist in such alternative embodiments.

FIG. 4 also depicts chuck jaws 42 that are mounted within the interior surface 44 of the first sleeve 39. The chuck jaws 42 have a threaded or rough surface 98 that are structured to engage the collar 12 when the collar 12 is received into the distal end 46 of the first sleeve 39. It is noted, however, that while FIGS. 1-4 show the use of a pair of chuck jaws 42, one or ordinary skill in the art would realize that one or more chuck jaws 42 could be used in the present invention and the depiction of a pair of chuck jaws 42 in FIGS. 1-4 should not be considered to be a limitation of the present invention.

As can be seen in FIGS. 1 and 2, the fastener removal apparatus 2 is assembled by cooperating the proximal end 100 of the second sleeve holder 78 on the housing 30 adjacent the ridge 32 with the rear half-rings 34, rear clamp ring 36, and rear snap ring 38 being mounted in the fashion described above. The cylindrical structural member 86 is slidingly disposed within the second sleeve 41. The threaded portion of the cylindrical structural member 86 is positioned adjacent to a proximal end 101 of the cutting blade 40. The cutting blade holder 82 is pinched between a first holding nut 102 and a second holding nut 104 thereby mounting the cutting blade holder 82 to the cutting blade 40. The first holding nut 102 and second holding nut 104 are threadably engaged with the threaded portion of the cylindrical structural member 86 of the cutting blade 40. However, one or ordinary skill in the art would recognize that any number of modifications can be made to secure the cutting blade 40 to the piston 28 and the actuator 6. The example provided in FIGS. 1-3 should not be considered to limit the scope of the present invention. A proximal end 106 of the cutting blade holder 82 is threadably engaged with the piston 28 of the actuator 6. A ball 108 on the cutting blade holder 82 is receivable in a detent on the piston 28 to resist unintended unthreading of the cutting blade holder 82 from the piston 28. The second sleeve 41 is threadably received into a distal end 110 of the second sleeve holder 78.

As can be seen in FIGS. 1 and 4, a clip or retaining ring 62 is placed around the exterior surface of the first sleeve 39 at the distal end 46 of the first sleeve 39. The clip or retaining ring 62 has laterally extending tabs 60 with an aperture 58 disposed therein that align with the slots 56 disposed through the exterior surface of the first sleeve 39. The chuck jaws 42 are located within the interior surface 44 of the first sleeve 39. The chuck jaws 42 are held within the interior surface 44 of the first sleeve 39 by pins 52 that extend generally perpendicularly to the axis 54 of the fastener 8 from the chuck jaws 42 through the slots 56 disposed through the exterior surface of the first sleeve 39 and through the aperture 58 of the laterally extending tabs 60 of the clip or retaining ring 62 and extending through the interior of the biasing members 64. The cutting blade 40 is then slidingly disposed into the grooves 96 of the first sleeve 39 as the flange 72 of the first sleeve 39 is positioned adjacent to the flange 76 of the second sleeve 41 and the pin 71 located on the first sleeve 39 is slidingly received within the aperture 73 located on the second sleeve 41. The front half-rings 70 are installed about the flange 72 of the first sleeve 39 and the flange 76 of the second sleeve 41. A front clamp ring 112 is installed about the front half-rings 76 and a front snap ring 114 is mounted to retain the front clamp ring 112 in an attached condition.

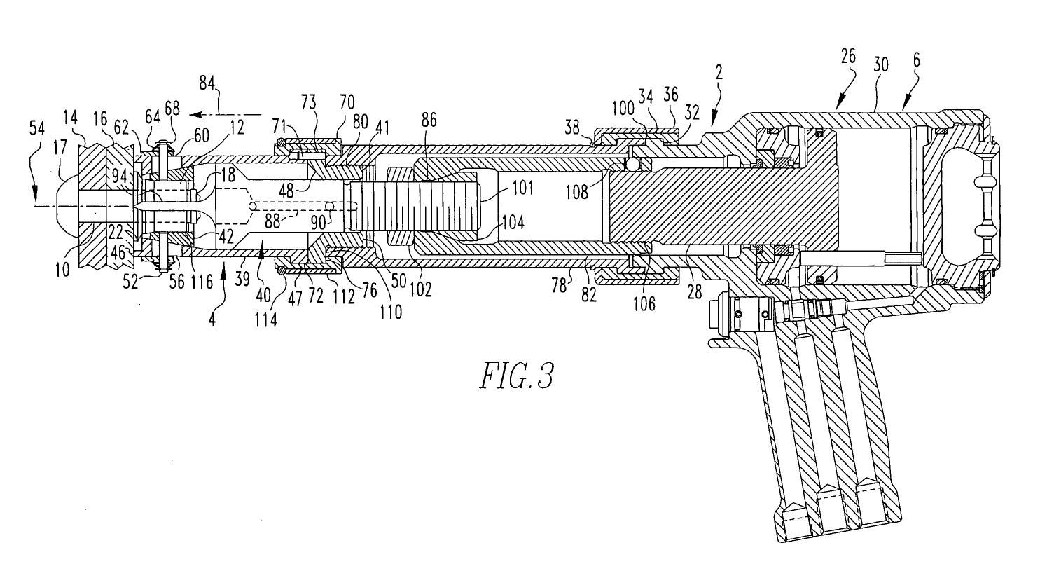

Just prior to the cutting operation, the swaged collar 12 is received into the distal end 46 of the first sleeve 39. Thereafter, the collar 12 is engaged by the threaded or rough surface 98 of the chuck jaws 42 by sliding the clip 62 along a preselected length of the first sleeve 39 from a first position to a second position toward the distal end 46 of the first sleeve 39 in order to cause the chuck jaws 42 to move axially inward toward the collar 12 to grippingly engage the chuck jaws 42 with the collar 12. While the operator manually moves the clip 62 along the preselected length from the first position to the second position, one of ordinary skill in the art would realize that the clip 62 could be moved from the first position to the second position with hydraulic, pneumatic, electric or other assistance. The actuator 6 can then be energized, which causes the piston 28 to translate along the cutting direction 84 with respect to the base 26, which direction is to the left in FIGS. 1 and 3 with respect to the base 26. Such translation of the piston 28 likewise translates the cutting blade holder 82 and the cutting blade 40 in the cutting direction 84. FIG. 3 depicts that such relative translation along the cutting direction 84 causes the blades 94 to cuttingly engage the collar 12 in the cutting direction 84 thereby cutting the collar 12 into cut portions 116. After cutting the collar 12, the chuck jaws 42 are disengaged from the collar 12 by slidingly moving the clip 62 along the preselected length of the first sleeve 39 from the second position to the first position in order to cause the chuck jaws 42 to move axially outward from the collar 12 to disengage the chuck jaws 42 from the collar 12. While the operator manually moves the clip 62 along the preselected length from the second position to the first position, one of ordinary skill in the art would realize that the clip 62 could be moved from the second position to the first position with hydraulic, pneumatic, electric or other assistance.

In performing the cutting operation, the blades 94 do not engage the pin 10 since the blades are spaced apart and therefore are not prematurely worn. The cutting engagement of the blades 94 with the collar 12 wedges the cut portions 116 of the collar 12 away from one another and away from the pin 10 during the cutting operation. As such, the collar 12 need not be further deformed after the cutting operation to remove the cut portions 116 of the collar 12 from the pin 10, which reduces the amount of energy and effort required to remove the collar 12 from the pin 10.

While the specification of this patent application is directed to use of the invention with swage-type fasteners, it should be noted that the invention could also be used to remove threaded nuts from threaded screws. As such, the collar described herein shall also be understood to cover a nut. Moreover, a condition in which a collar is affixed to or otherwise disposed on a pin shall also cover a nut threadably disposed on a threaded shank. Furthermore, while the FIGS. show the use of two blades 94, two chuck jaws 42, two slots 56, two tabs 60, two biasing members 64, two stop clips 68, two grooves 96, a slot 88, an aperture 92 and other components, one of ordinary skill in the art would recognize that modifications could be made to the number of such components used in the present invention and that one or more blades 94, chuck jaws 42, slots 56, tabs 60, biasing members 64, stop clips 68, grooves 96, slots 88, apertures and other components could be used in the present invention without departing from the teachings of the present invention and the present invention is not limited by the number of these components shown in the exemplary FIGS. While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof

What is claimed is:

1. A nose assembly structured to be mounted to an actuator of the type having a base and a translatable piston, said nose assembly being structured to be cooperable with a fastener having a pin and a collar with said collar being affixed to said pin, said nose assembly being structured to cut said collar to facilitate its removal from said pin, said nose assembly comprising:
a first sleeve having a preselected length;
one or more chuck jaws located within an interior surface of said first sleeve;
said chuck jaws structured to engage said collar when said collar is received into said first sleeve;
one or more cutting blades disposed within said first sleeve; and
said cutting blades being translatable along a cutting direction generally parallel with an axis of said fastener to cuttingly engage said cutting blades with said collar.

2. The nose assembly of claim 1 wherein:
said first sleeve has a distal end and a proximal end;
said first sleeve having a flange adjacent said proximal end and said interior surface tapering towards said distal end;
one or more slots disposed on a surface of said first sleeve;
one or more l grooves formed on said interior surface of said first sleeve;

3. The nose assembly of claim 2 further comprising a second sleeve, wherein said second sleeve has a distal end and a proximal end;
said second sleeve having a threaded portion adjacent said proximal end and a flange adjacent said distal end;
said second sleeve having one or more apertures located on a surface of said threaded portion;
said first and second sleeves are connected by a plurality of half rings that are installed about said flange of said first sleeve and said flange of said second sleeve;
said cutting blades having a generally cylindrical structural member with one or more slots disposed along a preselected length of said structural member; and
one or more holding pins disposed with said apertures of said second sleeve and said slots located along said preselected length of said structural member that prevents said cutting blades from rotating during translation of said piston.

4. The nose assembly of claim 2 further comprising:
a clip disposed around an exterior surface of said first sleeve at said distal end of said first sleeve with one or more laterally extending tabs with one or more apertures disposed therein that align with said slots on said first sleeve to receive one or more pins that extend from apertures disposed in an exterior surface of said chuck jaws generally perpendicular to said axis through said slots on said first sleeve and said apertures of said clip and is received into an interior region of one or more biasing members, said biasing members being secured to said pins by one or more stop clips;
said clip being slideable along a selected length of said first sleeve between a first position and a second position in order to grippingly engage said chuck jaws with said collar; and
said chuck jaws having a threaded or rough surface for engaging said collar when said collar is received into said distal end of said first sleeve.

5. The nose assembly of claim 3 wherein:
said cutting blades are slidingly disposed in said first sleeve and are received into said grooves of said first sleeve;
said generally cylindrical structural member having threads; and
said generally cylindrical structural member having one or more slots that extend along a preselected length of said cylindrical structural member, said slots receiving said holding pins thereby preventing said cutting blade from rotating in a radial direction during translation of said piston.

6. The nose assembly of claim 5 wherein:
said grooves comprises two grooves and are generally parallel with respect to said preselected length of said first sleeve;
said grooves has a first groove located directly opposite to a second groove
said cutting blade having a first blade and a second blade;
said first blade and said second blade each having an elongated cutting edge;
said cutting edges being spaced apart so that said cutting edges do not cuttingly engage said pin, said cutting edges being arranged in a substantially collinear fashion; and
said first blade being slidingly received in one of said grooves of said first sleeve and said second blade being slidingly received in another of said grooves of said first sleeve.

7. The nose assembly of claim 1 further comprising a fastener removal apparatus attached to said nose assembly.

8. The nose assembly of claim 1 wherein said pin is a threaded fastener and said collar is a nut.

9. The nose assembly of claim 1 wherein said first sleeve and said second sleeve and integrally connected together.

10. A nose assembly for removing a collar from a pin or a nut from a threaded fastener, said nose assembly comprising:
a generally tubular first sleeve of a preselected length having a distal end, a proximal end, an exterior surface, an interior surface, a through bore that passes through said interior surface, one or more slots disposed through said exterior surface into said interior surface of said first sleeve, and one or more grooves disposed within said interior surface of said first sleeve that passes along a preselected length of said interior surface of said first sleeve;
a generally cylindrical structural member of a preselected length having a first end and a second end, said first end having one or more blades disposed thereon, said preselected length of said structural member having a slot disposed along said preselected length of said structural member, said one or more blades of said structural member slidingly disposed within said one or more grooves of said first sleeve;
one or more chuck jaws disposed within said through bore of said first sleeve, said chuck jaws having one or more apertures disposed in an exterior surface of said chuck jaws;
a clip having one or more tabs extending from said clip with one or more apertures disposed within said tabs of said clip, said clip being disposed around said exterior surface of said first sleeve with said one or more apertures of said tabs aligning with said one or more slots disposed in said first sleeve and aligning with said one or more apertures disposed in said exterior surface of said chuck jaws;
one or more pins disposed within said one or more apertures disposed in said tabs of said clip, said one or more pins also disposed within said one or more slots in said first sleeve and said one or more apertures disposed in said exterior surface of said chuck jaws,
one or more biasing members surrounding said one or more pins;
one or more stop clips attached to said one or more pins thereby securing said biasing members around said pins;
a second sleeve disposed around said cylindrical structural member, said second sleeve having an exterior surface and an interior surface with an aperture disposed through said exterior surface into said interior surface of said second sleeve; said second sleeve having a distal end and a proximal end; and
a holding pin disposed within said aperture of said second sleeve and said slot located along said preselected length of said structural member with said structural member being slidingly disposed within said second sleeve.

11. The nose assembly of claim 10 wherein:
said first sleeve having a flange adjacent said proximal end;
said second sleeve having a flange adjacent said distal end;
said first sleeve and said second sleeve are connected by a plurality of half rings that are installed about said flange of said first sleeve and said flange of said second sleeve.

12. The nose assembly of claim 10 wherein said clip being slideable along a selected length of said first sleeve between a first position and a second position in order to grippingly engage said chuck jaws with said collar or said nut.

13. The nose assembly of claim 10 wherein:
said first end of said generally cylindrical structural member having a first blade and a second cutting blade;
said first cutting blade and said second cutting blade each having an elongated cutting edge;
said cutting edges being spaced apart so that said cutting edges do not cuttingly engage said pin or said fastener, said cutting edges being arranged in a substantially collinear fashion.

14. The nose assembly of claim 1 further comprising a fastener removal apparatus attached to said nose assembly.

15. The nose assembly of claim 1 wherein said first sleeve and said second sleeve are integrally connected together.

16. A method of removing a collar from a pin or a nut from a fastener, the method comprising:
providing a fastener release tool including an actuator, a first sleeve having a distal end and a proximal end, said first sleeve having one or more chuck jaws located within an interior surface of said first sleeve, said chuck jaws being connected to a clip disposed around said sleeve, one or more cutting blades, said first sleeve and said cutting blades being connected to said fastener release tool;
receiving said collar or said nut into said distal end of said sleeve;
engaging said chuck jaws to said collar or said nut;
translating with said actuator said cutting blades along a cutting direction generally parallel with an axis of said fastener;
cuttably engaging said blades with said collar or said nut along said cutting direction to form one or more cuts in said collar or said nut;
disengaging said cutting blades from said collar or said nut; and
disengaging said chuck jaws from said collar or said nut.

17. The method according to claim 15 wherein:
the step of engaging said collar or said nut with said chuck jaws includes the step of slidingly moving said clip along an exterior surface of said sleeve toward said distal end of said sleeve thereby causing said chuck jaws to move axially inward toward said collar or said nut to grippingly engage said collar or said nut; and
the step of disengaging said chuck jaws from said collar or said nut includes the step of slidingly moving said clip along an exterior surface of said sleeve toward said proximal end of said sleeve thereby causing said chuck jaws to move axially outward from said collar or said nut, said collar or said nut is fully disengaged with said chuck jaws.
